(19) United States
(12) Patent Application Publication
(10) Pub. No.: US 2021/0056946 A1
(43) Pub. Date: Feb. 25, 2021

(54) SOUND DAMPING RAILING

(71) Applicant: CPG International LLC, Scranton, PA (US)

(72) Inventor: Tammy Leigh Rucker, Chicago, IL (US)

(21) Appl. No.: 16/999,336

(22) Filed: Aug. 21, 2020

Related U.S. Application Data
(60) Provisional application No. 62/893,568, filed on Aug. 29, 2019.
(60) Provisional application No. 62/891,256, filed on Aug. 23, 2019.

(51) Int. Cl. G10K 11/168; E04F 11/18; B32B 7/12; B32B 1/08; B32B 15/082; B32B 15/20; B32B 15/18

(52) U.S. Cl. CPC G10K 11/168; E04F 11/1836; B32B 7/12; B32B 1/08; E04F 11/1808; B32B 15/20; B32B 15/18; E04F 2011/1889; E04F 2011/1874; B32B 15/082

(57) ABSTRACT

Aspects described herein relate metallic railings that include a sound damping polymeric material affixed to a surface of the railing. The metallic railing can be solid or hollow and can have a circular or non-circular cross section. By positioning the sound damping polymeric material on the inner surface or the underside surface of the metallic railing, the tone produced when the metallic railing is struck can be tuned.

### CROSS-REFERENCE TO RELATED APPLICATIONS

This application claims the benefit of U.S. Provisional App. No. 62/891,256, filed Aug. 23, 2019, and of U.S. Provisional App. No. 62/893,568, filed Aug. 29, 2019, the entirety of each of which is incorporated by reference herein.

### TECHNICAL FIELD

Aspects hereof relate to a railing with sound damping.

### BACKGROUND

A railing is traditionally used in connection with decking, balconies, stairs, and other surfaces as a barrier or to provide support to a person navigating the decking, stairs, or other surfaces. As such, railings are often intentionally or unintentionally contacted with enough force to produce an audible tone. The tone produced by railings made of certain materials can be off-putting or irritating. Said another way, traditional attempts to manufacture relatively less expensive metal railings can produce railings that sound “cheap.”

### BRIEF SUMMARY

Aspects hereof provide for a metallic railing having a sound damping polymeric material affixed to at least a portion of the railing. The railing includes a first surface that is generally the surface intended to be grabbed and an opposite second surface. The sound damping polymeric material is affixed to a portion of the second surface to dampen, or at least partially dampen, the tone produced by the railing. Additionally, the sound damping polymeric material may be “tuned” based on the vibrational frequency of the railing which is related to the particular metal, shape, or dimensional properties (e.g., length, thickness, and so forth) of the railing. Tuning the sound damping polymeric material can be facilitated by adjusting the polymeric composition of the sound damping polymeric material, including a backing or modifying the backing of the sound damping polymeric material, adjusting the dimensional properties of the sound damping polymeric material, adjusting the position or orientation of the sound damping polymeric material, or any combination thereof.

This summary is provided to enlighten and not limit the scope of methods and systems provided hereafter in complete detail.

### DESCRIPTION OF THE DRAWINGS

The present invention is described in detail herein with reference to the attached drawing figures, wherein:

FIG. 1 depicts an example of a railing system having a metallic railing, in accordance with aspects hereof;

FIG. 2 depicts an example of a metallic railing affixed to a structure, in accordance with aspects hereof;

FIGS. 3A and 3B depict a cross-sectional view of example metallic railings including sound damping polymeric materials affixed to a surface of the metallic railings, in accordance with aspects hereof;

FIGS. 4A-4E depict alternative longitudinal cross-sectional views of example metallic railings including a sound damping polymeric material, in accordance with aspects hereof;

FIGS. 5A-5D depict alterative cross-sectional views of example sound damping polymeric materials affixed to portions of a metallic railing, in accordance with aspects hereof;

FIGS. 6A and 6B depict an example multi-piece railing having affixed thereto one or more sound damping polymeric materials, in accordance with aspects hereof;

FIG. 6C depict a cross-sectional view of the railing in FIGS. 6A and 6B;

FIGS. 7A and 7B depict another example multi-piece railing having affixed thereto one or more sound damping polymeric materials, in accordance with aspects hereof; and

FIG. 7C depict a cross-sectional view of the railing in FIGS. 7A and 6B;

### DETAILED DESCRIPTION

The subject matter of the technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies.

Metallic railings, such as those described herein, can provide a number of benefits to decking, balconies, stairs, and other surfaces, materials, structures, or environments. For example, metallic railings are often used to provide support to a person using stairs, or to improve the safety of a balcony or deck. Metallic railings are also used to prevent, discourage, or limit entry into a particular area. However, the cost of some metals or metal alloys can be prohibitively expensive. Traditional approaches to reduce railing costs generally involve reducing the amount of metal or metal alloy in the railing. For example, by forming a hollow tube or appropriately shaping a relatively small amount of metal, the overall cost of the railing can be reduced. Cost can also be reduced by using less expensive metals or metal alloys.

However, the traditional attempts to reduce the cost of metal railings have problematic limitations. For instance, when a hollow or shaped metallic railing is struck it can produce a tone (e.g., audible sound) that is unappealing to some consumers. In essence, a tone is created when the kinetic energy of the contact is converted into vibrational energy that propagates through the railing. In turn, the vibrations of the railing alters the air pressure immediately around the railing, which is eventually perceived as a tone. Importantly, the shape and/or composition of a railing, at least partially, affects the efficiency of the energy propagation and the rate and magnitude of the vibration.

Attempts have been made to address such an unappealing tone. For example, increasing the thickness of metal of the hollow or shaped railings has been shown to produce a more appealing tone. However, this solution also has a problematic limitation. To increase the thickness while maintaining the other dimensions (e.g., length, circumference, etc.) more metal or metal alloy is used. Using more metal or metal alloy not only increases the cost, but also increases the weight of the railing. The increased weight can increase the difficulty of installation or render the railing incompatible for the intended purpose.

Accordingly, aspects hereof provide articles and systems directed to a metallic railing having a sound damping polymeric material affixed to a surface of the railing. For example, in various aspects, a metallic railing can be comprised of a first surface and a second surface and a sound damping polymeric material can be affixed to at least a first portion of the first and/or second surface of the metallic railing to dampen, or otherwise modify, the sound produced by the metallic railing when it is intentionally or unintentionally contacted. In such aspects, the sound damping can be achieved, at least partly, with the affixed polymeric material through dissipation or partial dissipation of the vibrational energy imparted by the contact. For example, at least some of the vibrational energy can be converted into heat.

In various aspects, the sound damping polymeric material may be tuned. In such aspects, tuning the sound damping polymeric material may enable some aspects described herein to alter the efficiency of energy storage or energy dissipation (e.g., as heat) of the sound damping polymeric material and in turn alter the propagation, rate, and magnitude of vibrational energy of the railing. Tuning may be desirable, in some aspects, based on one or more properties of the railing, such as, compositional properties, e.g., metals or metal alloys used in the railing, shape of the railing, dimensional properties (e.g., length, thickness, and so forth), or any combination thereof.

In some aspects, tuning the sound damping polymeric material can be facilitated by adjusting the polymeric composition of the sound damping polymeric material. For example, adjusting the polymeric composition may directly or indirectly affect the shear storage modulus, shear loss modulus, stiffness, mass and mode shape, or any combination thereof of the sound damping polymeric material, or the combination of the sound damping polymeric material and the metallic railing.

Additionally, or alternatively, in aspects, tuning the sound damping polymeric material can be facilitated by including a backing or modifying the backing of the sound damping polymeric material. In such aspects, including a backing or modifying the backing of the sound damping polymeric material, directly or indirectly, may affect the shear storage modulus, shear loss modulus, stiffness, mass and mode shape, or any combination thereof of the sound damping polymeric material.

Additionally, or alternatively, in aspects, tuning the sound damping polymeric material can be facilitated by adjusting the dimensional properties of the sound damping polymeric material, adjusting the position or orientation of the sound damping polymeric material, or any combination thereof. Adjusting the dimension, position, orientation, or any combination thereof may, directly or indirectly, affect the shear storage modulus, shear loss modulus, stiffness, mass and mode shape, or any combination thereof of the sound damping polymeric material.

In various aspects, as discussed further below, processes for determining a positioning for affixing sound damping polymeric material to a railing to achieve a desired effect, e.g., to lower a tone or resonant frequency of the railing when contacted by a user or object. In such aspects, the processes can include identifying or determining the resonant frequency of the railing, identifying any inconsistencies in the railing, identifying one or more sound damping polymeric materials based on the resonant frequency of the railing, identifying positions on the railing for affixing one or more sound damping polymeric materials, tuning, as discussed above, or a combination thereof.

As used herein, a sound damping polymeric material, in aspects, can refer to a polymer-based resin comprising one, more than one, or any combination of: acrylate monomers such as acrylic acid, methacrylate, methyl-methacrylate, acrylamide, hydroxy-ethyl acrylate, and others; butyl monomers, butyl copolymers such as copolymers of isobutylene, polyisobutylene, polyvinyl butyral, and others. Further, unless explicitly stated otherwise a sound damping polymeric material does not include materials used to join other structural or functional elements of a railing or railing assembly. Stated differently, the sound damping polymeric material is configured to dampen sound for a metallic railing and not to serve as a structural or functional element in a railing assembly. For example, tape or strapping provided with railing assembly portions for bundling or otherwise securing said railing assembly portions is not a sound damping polymeric material configured to dampen sound of a metallic railing.

A “railing” generally refers to an article that is designed to be grasped by the hand so as to provide stability or support. Unless explicitly stated otherwise, a railing can have any cross-sectional shape, but can generally classified as either circular (e.g., circular, elliptical, and so forth) or non-circular. In a specific example, a circular railing has a minimum outer diameter of 1 ¼ inches (32 millimeter (mm)). In a specific example, a non-circular railing has a minimum outer (e.g., hand contacting) perimeter dimension of 4 inches (100 mm).

The term “metal” and “metallic” are used interchangeably and consistent with the commonly understood meaning in the construction material and metallurgical arts. As such, metal refers to any material that intentionally contains at least one elemental metal. Similarly, the term “metal alloy” is used consistent with the commonly understood meaning in the construction material and metallurgical arts. For illustrative example and without limitation, a metal railing, such as those discussed herein, includes a railing comprised of iron, aluminum, titanium, nickel, tin, chrome, copper, zinc, or any combination thereof. Additionally, a metal railing includes a railing comprised of alloys of any metal, such as steel, stainless steel, wrought iron, anthracite iron, cast iron, pig iron, any other ferroalloy, brass, bronze, wrought aluminum alloys, cast aluminum alloys, or any other metal alloy.

The term “about” is used herein in relation to dimensional properties and accounts for variations in manufacturing tolerances. As such, about is used synonymously with ±10% of the relevant dimension in the relevant unit.

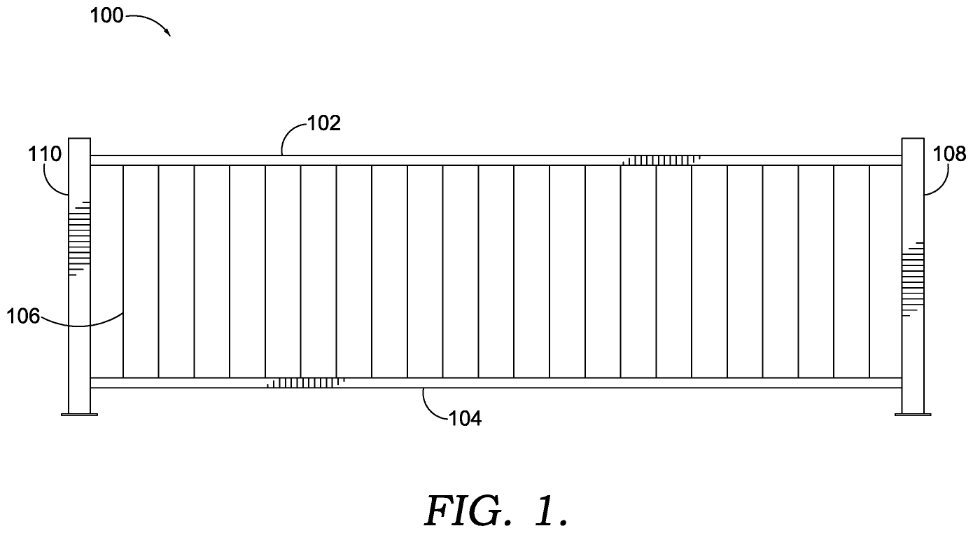

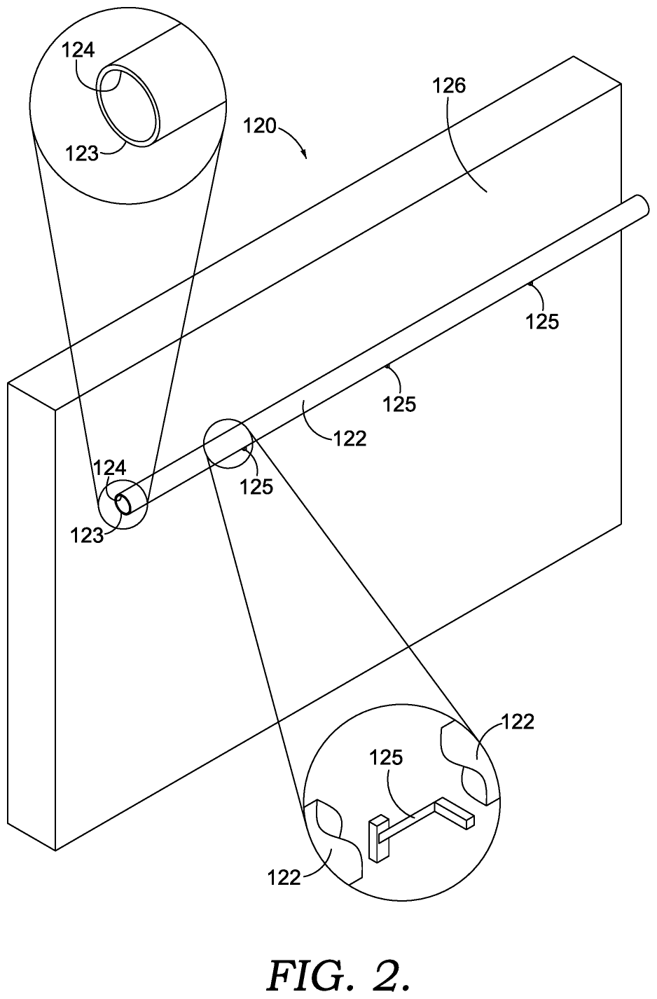

Turning to FIGS. 1 and 2, multiple examples of sound damping railings are depicted in accordance with aspects hereof. With brief reference to FIG. 1, an example railing assembly 100 having a top metallic railing 102 and a bottom metallic railing 104 is depicted in accordance with exemplary aspects hereof. As will be discussed in detail below, a railing or railing assembly, e.g., railing assembly 100, top metallic railing 102, bottom metallic railing 104, or any combination thereof, can include a polymeric sound damping material affixed to at least a portion of a surface of the metallic railing(s), in some aspects. Top metallic railing 102 and bottom metallic railing 104 can extend between two anchors, e.g., posts 108 and 110. Top metallic railing 102 and bottom metallic railing 104 can be secured to posts 108, 110 through any suitable means. Similarly, top metallic railing 102 and bottom metallic railing 104 can be secured to optional vertical segments 106 (e.g., balusters) through any suitable means. Vertical segments 106 can provide structural support, provide increased safety, provide aesthetic decoration, provide increased privacy, or a combination thereof for the railing assembly 100. As such, vertical segments 106 can be any suitable material for the intended purpose of railing assembly 100. Vertical segments 106 can be made of wood, metal, synthetic fiber, natural fiber, and/or polymer-based materials. Additionally, vertical segments 106 can be in any suitable form such as a cable, chain, slat, baluster, or any other form. It is contemplated that vertical segments 106 can be made of any material or combination of materials in any form or combination of forms. Although depicted with vertical segments 106, some aspects of railing assembly 100 can additionally, or alternatively, include horizontal segments extending between the anchor points and/or vertical segments 106.

With brief reference to FIG. 2, another example railing assembly 120 having a metallic railing 122 secured to a structure 126 is depicted in accordance with aspects described herein. Metallic railing 122 includes a first surface 123 and an opposite second surface 124. In an example aspect, first surface 123 is a superior surface and/or exterior surface (e.g., hand-contacting surface) of the metallic railing 122 and second surface 124 is an inferior surface and/or interior surface of the metallic railing 122. In aspects, metallic railing 122 can include a polymeric sound damping material affixed to at least a portion of the second surface 124 of the metallic railing 122. Metallic railing 122 can be attached to structure 126 through any suitable means. For example, metallic railing 122 can be secured to structure 126 via a plurality of mounting brackets 125. Structure 126 can include any natural or manufactured object (such as an interior or exterior wall of a building, stairwell, tunnel, fence, boulder, or similar objects). Metallic railing 122 can be positioned at any position on structure 126.

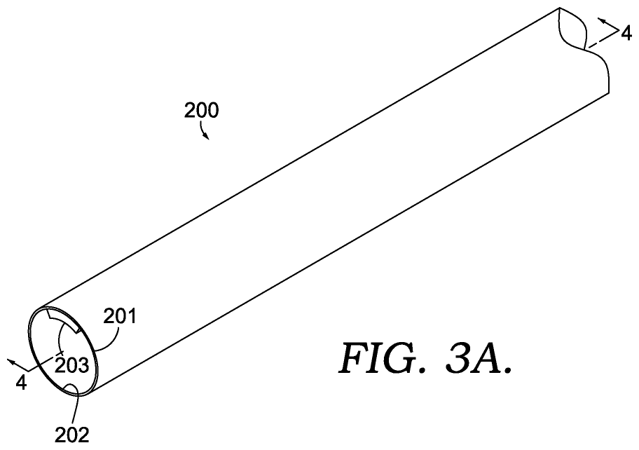

Turning to FIGS. 3A and 3B, cross sections of illustrative example metallic railings 200 and 210, respectively, are depicted in accordance with aspects described herein. Example metallic railings 200, 210 may be comprised of a metal or metal alloy. For example, some aspects of metallic railings 200, 210 can be comprised of iron, aluminum, titanium, nickel, tin, chrome, copper, zinc, or any combination thereof. Additionally, or alternatively, metallic railings 200, 210 are comprised of alloys of iron, aluminum, titanium, nickel, tin, chrome, copper, zinc, or any combination thereof in some aspects.

Generally, metallic railings (such as metallic railings 200, 210) can be extruded, milled, rolled, cut, bent, cast, or shaped to have any regular or irregular cross-sectional shape. The metallic railings 200, 210 may be solid or hollow. For example and without limitation, example metallic railing 200 has a cross-section shape that is generally circular with a hollow central portion that extends longitudinally. Example metallic railing 200 can be manufactured by any suitable method including, illustratively, shaping of a sheet of metal or metal alloy into a hollow cylindrical shape. In an example aspect, the circular cross section of a metal railing has a minimum outer diameter of 1 ¼ inches (32 mm). The metallic railings may be any length (e.g., 4 ft. to 8 ft. or any other length).

With specific reference to FIG. 3A, example metallic railing 200 includes a first surface 201 and a second surface 202. The first surface 201 is an exterior-facing surface that is generally intended for grasping by the hand. The second surface 202 is an interior-facing surface that is opposite the exterior-facing surface (i.e., first surface 201). In some aspects, metallic railing 200 includes a sound damping polymeric material 203 affixed to at least a first portion of the second surface 202. The first portion of the second surface 202 can be any size, shape, or located at any position of the second surface 202. For example, in some aspects the sound damping polymeric material 203 can be affixed to an interior upper portion, an interior side portion, an interior bottom portion, or a combination thereof, of the second surface 202. As used herein, relative terms of position (e.g., upper, side, lower) refer to an intended orientation when the railing (or railing assembly) is in an in-use configuration. For example, the sound damping polymeric material 203 is illustrated in FIG. 3A as being affixed to an interior upper portion of the second surface 202. In some aspects, metallic railing 200 may comprise a top rail or a bottom rail of a railing assembly (such as top metallic railing 102 or bottom metallic railing 104 of railing assembly 100 depicted in FIG. 1). Alternatively, metallic railing 200 may comprise a railing that is affix-able to a structure (such as metallic railing 122 depicted in FIG. 2).

Turning to FIG. 3B, example metallic railing 210 has a non-circular cross section that is a non-enclosed or open structure. Example metallic railing 210 includes a first surface 211 that forms the top side of metallic railing 210. Additionally, metallic railing 210 includes a second surface 212 that forms the underside of the metallic railing 210. In some aspects, metallic railing 210 includes a sound damping polymeric material 213 affixed to at least a first portion of the second surface 212. In some aspects, metallic railing 210 additionally includes another sound damping polymeric material 214 affixed to at least a second portion of the second surface 212. In some aspects, metallic railing 210 may comprise a top rail or a bottom rail of a railing assembly (such as top metallic railing 102 or bottom metallic railing 104 of railing assembly 100 depicted in FIG. 1). Alternatively, metallic railing 210 may comprise a railing that is affix-able to a structure (such as metallic railing 122 depicted in FIG. 2).

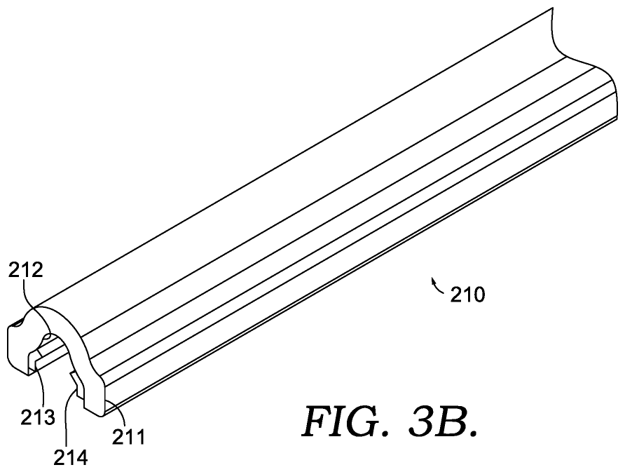

FIGS. 4A-4E depict cross-sectional views along a longitudinal direction (e.g., lengthwise) of metallic railings 200 of FIG. 3A, in accordance with aspects hereof. FIGS. 4A-4E provide various, non-limiting, illustrative orientations, spacing, sizes, and configurations of one or more sound damping polymeric materials affixed to a portion of metallic railing 200 viewed from cross section 4-4. However, it is understood that any one or more the configurations depicted in FIGS. 4A-4E may be used exclusively or in combination with other configurations. Stated differently, while a plurality of polymeric materials configurations are depicted in the cross-sectional view from the metallic railing 200 in FIGS. 4A-4E, this collection is illustrative only, and instead, a single configuration or combination of configurations are contemplated herein.

With specific reference to FIG. 4A, metallic railing 300 includes a first surface 301 and a second surface 302. As used herein, reference to a first surface and a second surface in connection with FIGS. 4A-4E are specific portions of the first surface 201 and the second surface 202 respectively of FIG. 3A. The shape of the polymeric material may be any shape. However, in some aspects, the polymeric material is a strip having a length, width, and thickness. The length may be greater than the width. The width may be greater than the thickness. In some aspects, the length of sound damping polymeric material 304 can be perpendicular to the longitudinal direction of the metallic railing 300. Said another way, the longest axis of sound damping polymeric material 304 can be oriented perpendicular to the longest dimension of the metallic railing 301. The length 303 of sound damping polymeric material 304 can be less than or equal to an inner circumference of metallic railing 301. Said another way, in some aspects the length 303 of sound damping polymeric material 304 can wrap completely around/across or partially around/across the second surface of a metallic railing. Alternatively, in some aspects, the length of sound damping polymeric material 304 can be less than or equal to the length of the second surface 302 transverse to a longitudinal length of the second surface 302. Said another way, in some aspects the length 303 of sound damping polymeric material 304 can wrap completely across or partially across the perimeter of the second surface of a metallic railing with a non-circular cross section.

The sound damping polymeric material 304 is affixed to at least a first portion of the second surface 302. The first portion may be at any location of the second surface 302 and may vary based on the composition, size, shape, or any combination thereof of the metallic railing 300. Additionally, in some aspects, a second sound damping polymeric material can be affixed to a second portion of the second surface 302.

Now with specific reference to FIG. 4B, metallic railing 310 includes a first surface 311 and a second surface 312. In some aspects, sound damping polymeric material 314 can be helically oriented around the longitudinal direction of the metallic railing 310. Said another way, the sound damping polymeric material 314 can be pitched at an angle such that the lead 317 is greater than or equal to the width 315 of the sound damping polymeric material 314. As used herein, lead refers to the axial advance of a helix during one complete turn. Sound damping polymeric material 314 is affixed to at least a first portion of the second surface 312. The first portion may be at any location of the second surface 312 and may vary based on the composition, size, shape, or any combination thereof of metallic railing 310. The length of sound damping polymeric material 314 can vary based on the pitch or lead of sound damping polymeric material 314 or the composition, size, or shape of metallic railing 310, or any combination thereof. Affixing the sound damping polymeric material 314 in a helical orientation may help tune the sound produced by metallic railing 310 via improved sound damping properties by disrupting potential resonance frequencies of some metallic railings, in certain aspects.

Additionally, in some aspects a second sound damping polymeric material can be affixed to a second portion of the second surface 312. The second portion of the second surface 312 can be continuous or discontinuous with the first portion of second surface 312. Said another way, the sound damping polymeric material 314 can be continuous or discontinuous with the second sound damping polymeric material. In some aspects, the length of the second sound damping polymeric material in the longitudinal direction of the metallic railing 310 can be 99% to 101% of the length of the sound damping polymeric material 314 in the longitudinal direction of the metallic railing 310. For example, in some aspects, the length of the second sound damping polymeric material being 99%-101% of the length of the sound damping polymeric material 314 provides a length-tuned polymeric material that is effective on a common metallic railing. In some aspects, the length of the second sound damping polymeric material in the longitudinal direction of the metallic railing 310 is 90% to 110% of the length of the sound damping polymeric material 314 in the longitudinal direction of the metallic railing 310. For example, in some aspects, the length of the second sound damping polymeric material being 90%-110% of the length of the sound damping polymeric material 314 provides a tone specific tuning that is effective on a common metallic railing. In some aspects, the length of the second sound damping polymeric material in the longitudinal direction of the metallic railing 310 is greater than 110% of the length of the sound damping polymeric material 314 in the longitudinal direction of the metallic railing 310. For example, in some aspects the length of the second sound damping polymeric material being greater than 110% of the length of the sound damping polymeric material 314 can disrupt resonance patterns of long wavelength vibrations of a metallic railing. In some aspects, the length of the second sound damping polymeric material in the longitudinal direction of the metallic railing 310 is less than 90% of the length of the sound damping polymeric material 314 in the longitudinal direction of the metallic railing 310. For example, in some aspects the length of the second sound damping polymeric material being less than 90% of the length of the sound damping polymeric material 314 can disrupt resonance patterns of short wavelength vibrations of a metallic railing.

Turning to FIG. 4C, metallic railing 320 includes a first surface 321 and a second surface 322. In some aspects, the length 326 of sound damping polymeric material 324 can be oriented parallel or approximately parallel with the longitudinal direction of the metallic railing 320. Sound damping polymeric material 324 may be affixed to at least a first portion of the second surface 322. The first portion may be at any location of the second surface 322 and may vary based on the composition, size, shape, or any combination thereof, of metallic railing 320. For example, in some aspects the first portion can be at the top, bottom, or either side of the second surface 322. In aspects, the length 326 and thickness 325 of sound damping polymeric material 324 can vary based on the composition, size, shape, or any combination thereof, of metallic railing 320.

Additionally, in some aspects a second sound damping polymeric material can be affixed to a second portion of the second surface 322. The second portion of the second surface 322 can be continuous or discontinuous with the first portion of second surface 322. In some aspects, the length of the second sound damping polymeric material in the longitudinal direction of the metallic railing 320 is 99% to 101% of the length 326 of the sound damping polymeric material 324 in the longitudinal direction of the metallic railing 320. In some aspects, the length of the second sound damping polymeric material in the longitudinal direction of the metallic railing 320 is 90% to 110% of the length 326 of the sound damping polymeric material 324 in the longitudinal direction of the metallic railing 320. In some aspects, the length of the second sound damping polymeric material in the longitudinal direction of the metallic railing 320 is greater than 110% of the length 326 of the sound damping polymeric material 324 in the longitudinal direction of the metallic railing 320. In some aspects, the length of the second sound damping polymeric material in the longitudinal direction of the metallic railing 320 is less than 90% of the length 326 of the sound damping polymeric material 324 in the longitudinal direction of the metallic railing 320.

Turing to FIG. 4D, metallic railing 330 includes a first surface 331 and a second surface 332. Metallic railing 330 also includes a first sound damping polymeric material 334 affixed to a first portion of second surface 332 and a second sound damping polymeric material 336 affixed to a second portion of second surface 332. In some aspects, the length 333 of a first sound damping polymeric material 334 can be oriented parallel or approximately parallel with the longitudinal direction of the metallic railing 330. In some aspects, the length 337 of a second sound damping polymeric material 336 can be oriented parallel or approximately parallel with the longitudinal direction of the metallic railing 330. The first sound damping polymeric material 334 can be opposite and at least partially aligned with the second sound damping polymeric material 336. Said another way, the first sound damping polymeric material 334 can be affixed to a top portion of the second surface 332 and/or the second sound damping polymeric material 336 can be affixed to a bottom portion of the second surface 332, in certain aspects. However, the first portion may be at any location of the second surface 332 and may vary based on the composition, size, shape, or any combination thereof, of metallic railing 330. For example, the first portion can be at the top, bottom, or either side of the second surface 332. Similarly, the second portion can be at the bottom, top, or either side of the second surface 332.

The length 333, 337 and thickness 335, 339 of sound damping polymeric material 334, 336, respectively, can vary based on the composition, size, shape, or any combination thereof of metallic railing 330. For example, in some aspects the length 337 of the second sound damping polymeric material 336 in the longitudinal direction of the metallic railing 330 is 99% to 101% of the length 333 of the sound damping polymeric material 334 in the longitudinal direction of the metallic railing 330. In some aspects, the length 337 of the second sound damping polymeric material 336 in the longitudinal direction of the metallic railing 330 is 90% to 110% of the length 333 of the sound damping polymeric material 334 in the longitudinal direction of the metallic railing 330. In some aspects, the length 337 of the second sound damping polymeric material 336 in the longitudinal direction of the metallic railing 330 is greater than 110% of the length 333 of the sound damping polymeric material 334 in the longitudinal direction of the metallic railing 330. In some aspects, the length 337 of the second sound damping polymeric material 336 in the longitudinal direction of the metallic railing 330 is less than 90% of the length 333 of the sound damping polymeric material 334 in the longitudinal direction of the metallic railing 330.

Turning to FIG. 4E, metallic railing 340 includes a first surface 341 and a second surface 342. Metallic railing 340 also includes a first sound damping polymeric material 344 affixed to a first portion of second surface 342 and a second sound damping polymeric material 346 affixed to a second portion of second surface 342. In some aspects, the length 343 of a first sound damping polymeric material 344 can be oriented parallel or approximately parallel with the longitudinal direction of the metallic railing 340. In some aspects, the length 347 of a second sound damping polymeric material 346 can be oriented parallel or approximately parallel with the longitudinal direction of the metallic railing 340. The first sound damping polymeric material 344 can be opposite and at least partially offset from the second sound damping polymeric material 346. Said another way, in aspects, the first sound damping polymeric material 344 can be affixed to a top portion of the second surface 342 and/or the second sound damping polymeric material 346 can be affixed to a bottom portion of the second surface 342 at an, at least partially, asymmetrical position. Similarly, the second sound damping polymeric material 346 can be affixed to a second portion at either side of the second surface 342.

The length 343, 347 and thickness 345, 349 of sound damping polymeric material 344, 346, respectively, can vary based on the composition, size, shape, or any combination thereof of metallic railing 340. For example, in some aspects, the length 347 of the second sound damping polymeric material 346 in the longitudinal direction of the metallic railing 340 is 99% to 101% of the length 343 of the sound damping polymeric material 344 in the longitudinal direction of the metallic railing 340. In some aspects, the length 347 of the second sound damping polymeric material 346 in the longitudinal direction of the metallic railing 340 is 90% to 110% of the length 343 of the sound damping polymeric material 344 in the longitudinal direction of the metallic railing 340. In some aspects, the length 347 of the second sound damping polymeric material 346 in the longitudinal direction of the metallic railing 340 is greater than 110% of the length 343 of the sound damping polymeric material 344 in the longitudinal direction of the metallic railing 340. In some aspects, the length 347 of the second sound damping polymeric material 346 in the longitudinal direction of the metallic railing 340 is less than 90% of the length 343 of the sound damping polymeric material 344 in the longitudinal direction of the metallic railing 340.

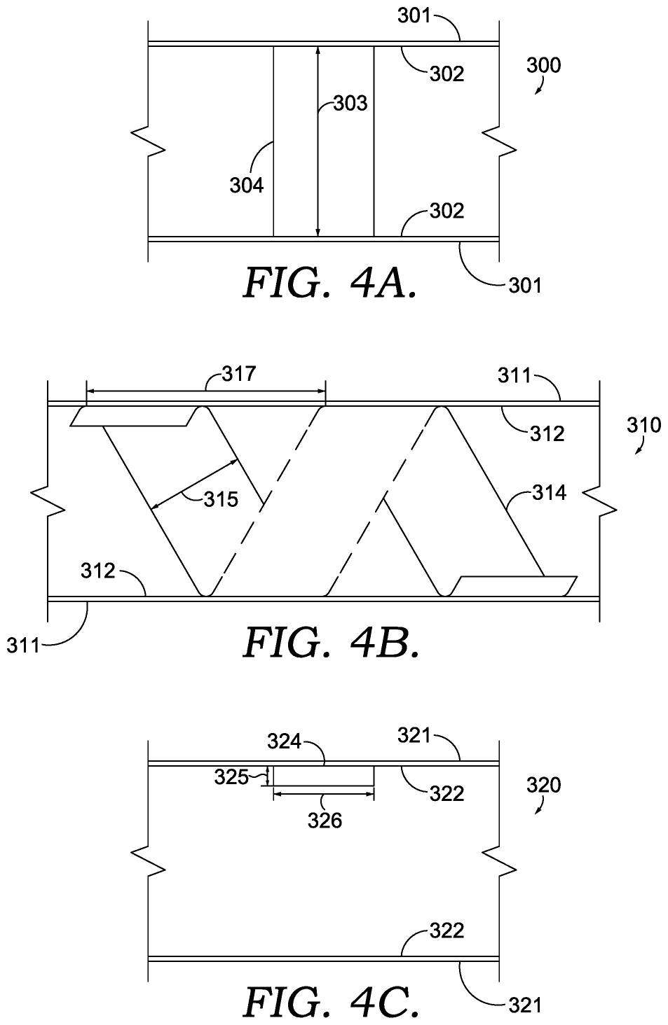

FIGS. 5A-5D depict cross-sectional views 400, 420, 440, 460 of a sound damping polymeric material affixed to a second side of a metallic railing, in accordance with aspects described herein. With specific reference FIG. 5A, a portion of a metallic railing 401, which may represent the top metallic railing 102 of FIG. 1, is depicted and can include a first surface 402, a second surface 403, and a sound damping polymeric material 405 that is affixed to a portion of the second surface 403. In aspects, the sound damping polymeric material 405 is comprised of an adhesive layer 406 that is proximate the second surface 403 and a polymer-based second layer 407.

The adhesive layer 406 can comprise any material suitable to affix the sound damping polymeric material 405 to a portion of the second surface 403. In some aspects, the adhesive layer 406 is comprised of a polymer-based adhesive. For example, the adhesive layer 406 can include an acrylate, a methacrylate, an acrylamide, a methacrylamide, a butadiene-styrene, a polymerized butyl monomer, polyvinyl butyral, polyisobutylene or any combination thereof.

The polymer-based second layer 407 can be comprised of the same polymer as that of the adhesive layer 406 or any other polymer such as polyvinyl chloride, polyethylene, polypropylene, polyvinyl butyral, ethylene-vinyl acetate, thermoplastic polyurethane, polyester, polyethylene terephthalate.

Additionally, in some aspects, sound damping polymeric material 405 is comprised of a backing layer 408. Backing layer 408 can comprise a metal or polymer material proximate the polymer-based second layer 407. For example, backing layer 408 can be aluminum, zinc, iron, steel, any other metal or polyvinyl chloride, polyethylene, polypropylene, polyvinyl butyral, ethylene-vinyl acetate, thermoplastic polyurethane, polyester, polyethylene terephthalate, or any other polymer. Backing layer 408 can be included in some aspects to improve the sound damping properties of the sound damping polymeric material based on composition, size, and shape of the particular metallic railing 401. A backing layer 408 can increase the shear-related energy dissipation of the sound damping polymeric material 405. By increasing the energy dissipation the sound damping polymeric material 405 increases the conversion of vibrational energy to heat, which reduces the conversion of vibrational energy to sound for the system as a whole.

The sound damping polymeric material 405 has an overall thickness 409. The overall thickness 409 includes the thickness of the adhesive layer 406, the polymer-based second layer 407, and, in some aspects, backing layer 408. Overall thickness 409 can vary based on the composition, size, and shape of the particular metallic railing 401. For example, in an illustrative aspect, overall thickness 409 is about 9.8 thousandths of an inch (about 0.25 mm) as determined by PSTC-133 (16^{th} edition of Test Methods for Pressure Sensitive Adhesive Tapes, published by the Pressure Sensitive Tape Council). In such an example aspect, the combined thickness of the adhesive layer 406 and the polymer-based second layer 407 can be between about 9.8 thousandths of an inch (about 0.25 mm) and about 2.8 thousandths of an inch (about 0.07 mm), as determined by PSTC-133. Optionally, in aspects, the thickness of backing layer 408 can be between about 7.0 thousandths of an inch (about 0.18 mm) and 2.8 thousandths of an inch (0.07 mm). In a specific aspect, the combined thickness of the adhesive layer 406 and the polymer-based second layer 407 is about 4.8 thousandths of an inch (about 0.12 mm), and the thickness of the backing layer 408 is about 5.0 thousandths of an inch (about 0.13 mm) as determined by PSTC-133.

With specific reference to FIG. 5B, a portion of a metallic railing 421 is depicted including a first surface 422, a second surface 423, and a sound damping polymeric material 425 that is affixed to a portion of the second surface 423. The sound damping polymeric material 425 can be comprised of an adhesive layer 426 that is proximate the second surface 423 and a polymer-based second layer 427. Additionally, some aspects of sound damping polymeric material 425 is further comprised of a backing layer 428. The sound damping polymeric material 425 has an overall thickness 429. The overall thickness 429 includes the thickness of the adhesive layer 426, the polymer-based second layer 427, and, in some aspects, backing layer 428. Overall thickness 429 can vary based on the composition, size, and shape of the particular metallic railing 421. For example, the overall thickness 429 can be greater than 9.8 thousandths of an inch (greater than 0.25 mm) in some aspects to dampen the resonance of a particular metallic railings 421. An overall thickness 429 greater than 9.8 thousandths of an inch may provide enhanced sound damping by increasing the energy dissipation of the sound damping polymeric material 425. By increasing the energy dissipation, the sound damping polymeric material 425 increases the conversion of vibrational energy to heat, which reduces the conversion of vibrational energy to sound for the system as a whole.

With specific reference to FIG. 5C, a portion of a metallic railing 441 is depicted including a first surface 442, a second surface 443, and a sound damping polymeric material 445 that is affixed to a portion of the second surface 443. The sound damping polymeric material 445 is comprised of an adhesive layer 446 that is proximate the second surface 443 and a polymer-based second layer 447. The sound damping polymeric material 445 has an overall thickness 449. In such an aspect, the overall thickness 449 includes the thickness of the adhesive layer 446 and the polymer-based second layer 447. Overall thickness 449 can vary based on the composition, size, and shape of the particular metallic railing 441. For example, in an illustrative aspect, overall thickness 449 is about 9.8 thousandths of an inch (about 0.25 mm). The overall thickness 449 can be greater than 9.8 thousandths of an inch (greater than 0.25 mm) in some aspects to dampen the resonance of particular metallic railings 441. An overall thickness 449 greater than 9.8 thousandths of an inch can provide enhanced sound damping, in aspects. Additionally, some aspects of the sound damping polymeric material (such as sound damping polymeric material 445) do not include a backing layer, based on the composition, size, and shape of a particular metallic railing (such as metallic railing 441). For example, a backing layer may be omitted from the sound damping polymer material in particular aspects where the additional weight of the backing layer is problematic and/or unnecessary for the intended purpose of the particular metallic railing.

With specific reference to FIG. 5D, a portion of a metallic railing 461 is depicted including a first surface 462, a second surface 463, and a sound damping polymeric material 465 that is affixed to a portion of the second surface 463. The sound damping polymeric material 465 is comprised of an adhesive layer 466 that is proximate the second surface 463 and a polymer-based second layer 467. Additionally, some aspects of sound damping polymeric material 465 can further comprise a backing layer 468. The sound damping polymeric material 465 has an overall thickness 469. In such aspects, the overall thickness 469 includes the thickness of the adhesive layer 466 and the polymer-based second layer 467. Overall thickness 469 can vary based on the composition, size, and shape of the particular metallic railing 461. For example, in an illustrative aspect, overall thickness 469 is about 9.8 thousandths of an inch (about 0.25 mm). The overall thickness 469 can be less than 9.8 thousandths of an inch (less than 0.25 mm) in some aspects to tune the tone produced by particular metallic railings, e.g., metallic railing 461.

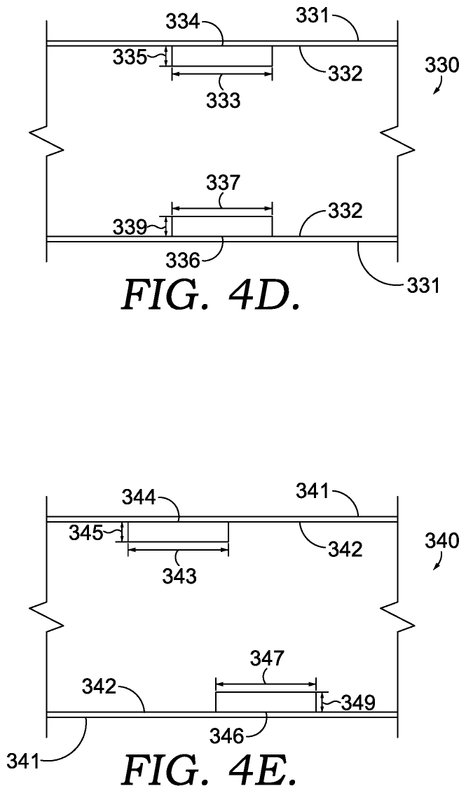

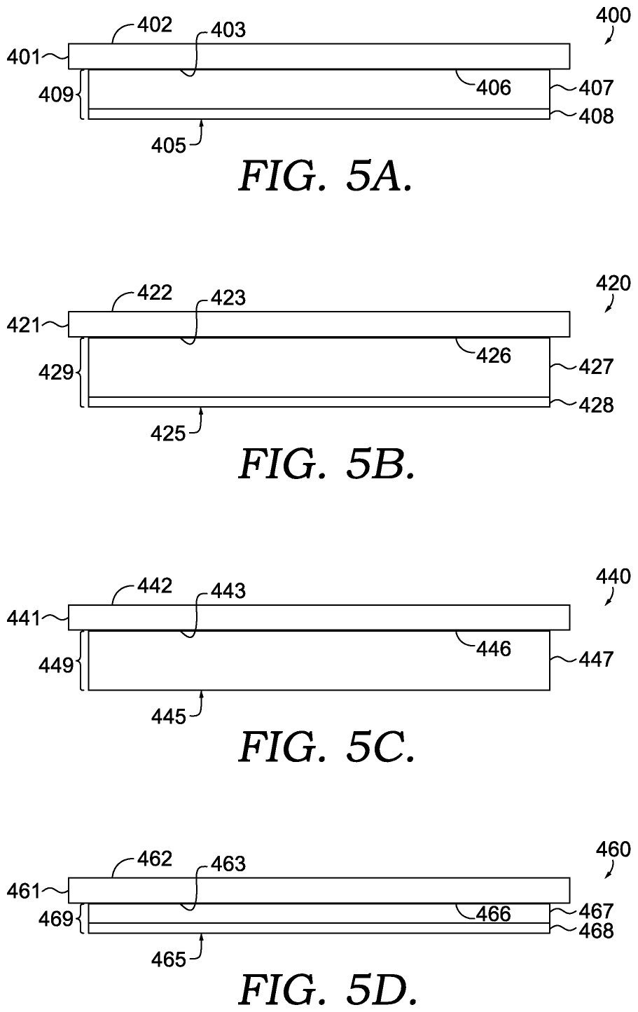

In various aspects, the present disclosure also contemplates affixing sound damping polymeric material to a multi-piece railing. For instance, in aspects, one or more sound damping polymeric materials can be affixed to a multi-piece metallic railing, such as the railing 500 depicted in FIGS. 6A-6C. The railing 500 depicted in FIGS. 6A-6C can include a bottom piece 520 and a cap 510. In such aspects, the cap 510 may fit over at least a portion of the bottom piece 520 when assembled, as depicted in FIGS. 6A and 6C, thereby forming a multi-piece, e.g., a two-piece railing. In certain aspects, the cap 510 may be secured to the bottom piece 520 using one of more fasteners. In such aspects, any convenient fasteners may be utilized to secure the cap 510 to the bottom piece 520. In alternative aspects, the cap 510 may be secured to the bottom piece 520 without fasteners. It should be understood that the railing 500 depicted in FIGS. 6A-6C is just one example of a multi-piece railing and that the other types of multi-piece railings are also contemplated by the disclosure herein.

In aspects, the railing 500 can comprise and/or be formed from a metal or metal alloy. In certain aspects, the railings disclosed herein, e.g., the railing 500, can comprise or be formed from metals or metal alloys that include iron, aluminum, titanium, nickel, tin, chrome, copper, zinc, or any combination thereof. As discussed above, in aspects, a metallic railing, such as the railing 500, can be extruded, milled, rolled, cut, bent, cast, or shaped to have any regular or irregular cross-sectional shape. In aspects, the railing 500 can be manufactured by any suitable method including, illustratively, shaping of a sheet of metal or metal alloy into a desired shape. In an example aspect, the railing 500, the bottom piece 520, and/or the cap 510, can exhibit a maximum width, e.g., a width 501, of about 0.5 inches (12.7 mm) or more, and/or of about 12 inches (304.8 mm) or less.

In aspects, and as best seen in FIGS. 6B and 6C, the cap 510 includes an inner surface 512 and an opposing outer surface 511, where the outer surface 511 may come into contact with a user, e.g., a hand of a user. As depicted in FIG. 6B, the bottom piece 520 can include an outer surface 521 and an inner surface 522.

As discussed above, in various aspects, the sound damping railings disclosed herein may include one or more sound damping polymeric materials affixed thereto. For example, as can be seen in the aspect depicted in FIGS. 6A-6C, the railing 500 can include sound damping polymeric materials 514 and 524. In aspects, the sound damping polymeric materials 514 and 524 can include any or all of the properties and parameters of the sound damping polymeric materials discussed above, including the sound damping properties and parameters discussed above with reference to FIGS. 3A-5D.

In the aspect depicted in FIGS. 6A-6C, sound damping polymeric material 514 can be affixed to a first portion of the inner surface 512 of the cap 510 and/or sound damping polymeric material 524 can be affixed to a first portion of the inner surface 522 of the bottom piece 520. In aspects, the first portion of the inner surface 512 can be any size, shape, or located at any position of the inner surface 512. In the same or alternative aspects, the first portion of the inner surface 522 can be any size, shape, or located at any position of the inner surface 522. In the example aspect depicted in FIGS. 6A-6C, the sound damping polymeric materials 514 and 524 are positioned so that the maximum dimension of the sound damping polymeric materials 514 and 524 generally extends in a direction parallel or substantially parallel to the width direction of the railing 500, depicted as the width 501. Stated differently, the sound damping polymeric materials 514 and 524 are positioned so that the maximum dimension of the sound damping polymeric materials 514 and 524 generally extends in a direction that is transverse or oblique to the lengthwise extension of the railing 500, as depicted by the length 502 in FIG. 6A.

It should be understood that the railing 500 and the number of and position of the sound damping polymeric materials 514 and 524 depicted in FIGS. 6A-6C is just one example railing having sound damping polymeric materials affixed thereto. For instance, in an aspect not depicted in FIGS. 6A-6C, one or more sound damping polymeric materials can be positioned on the outer surface 521 of the bottom piece 520 and/or on the outer surface 511 of the cap 510. In certain aspects, the cap 510 may include multiple sound damping polymeric materials at positions spaced apart from one another and/or at intervals throughout the inner surface 512 of the cap 510. In various aspects, the bottom piece 520 may include multiple sound damping polymeric materials at positions spaced apart from one another and/or at intervals throughout the inner surface 522 of the bottom piece 520.

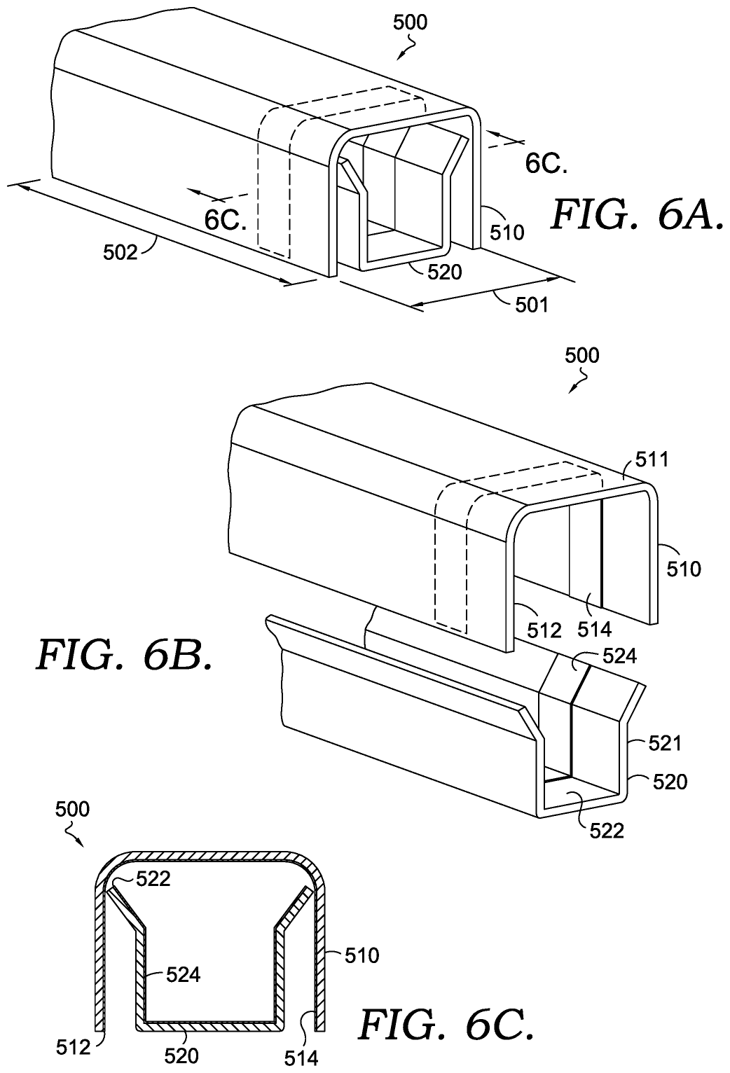

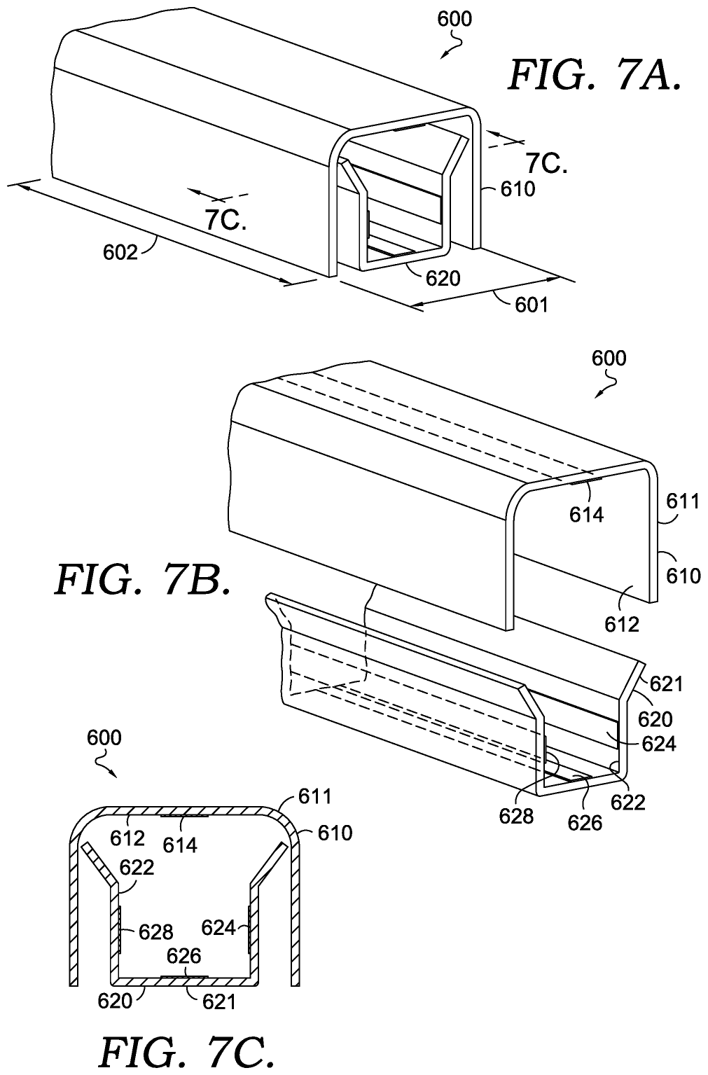

FIGS. 7A-7C depict another example of sound damping polymeric materials affixed to a multi-piece railing, e.g. the railing 600. In aspects, the railing 600 is structurally similar to the railing 500 depicted in FIGS. 6A-6C. For example, the length, as depicted by the length 602, and the width, as depicted by the width 601, can be similar to the length 502 and width 501 of the railing 500. In aspects, the railing 600 can include a cap 610 and a bottom piece 620, that when assembled, form a two-piece railing. In aspects, the cap 610 can include an outer surface 611 and an opposing inner surface 612. In the same or alternative aspects, the bottom piece 620 can include an inner surface 622 and an opposing outer surface 621. The properties and parameters of the railing 500 discussed above with reference to FIGS. 6A-6C, in certain aspects, can apply to the railing 600. For instance, the materials and methods of forming the railing 600 can, in certain aspects, be the same or similar to those discussed above with reference to the railing 500.

The railing 600 depicted in FIGS. 7A-7C is depicted, in part, to illustrate a different configuration of sound damping polymeric materials than that depicted in FIGS. 6A-6C. For instance, as best seen in FIGS. 7B and 7C, the sound damping polymeric materials depicted therein include a maximum dimension that extends parallel or substantially parallel to the lengthwise extension of the railing 600, as depicted by the length 602 in FIG. 7A. In such aspects, sound damping polymeric material 614 can be positioned on a portion of an inner surface 612 of the cap 610, where the maximum dimension of the sound damping polymeric material 614 extends in a direction parallel or substantially parallel to the lengthwise extension of the railing 600. Further, in the same or alternative aspects, the sound damping polymeric materials 624, 626, and 628 can be positioned on portions of the inner surface 622 of the bottom piece 620, where the maximum dimension of each of the sound damping polymeric materials 624, 626, and 628 extends in a direction parallel or substantially parallel to the lengthwise extension of the railing 600. It should be understood that the depicted portions and/or positions of the sound damping polymeric materials 614, 624, 626, and/or 628 are just one example and that the depicted portions can be any size, shape, or located at any position of the inner surface 612 and/or 622.

It should also be understood that the railing 600 and the number of and position of the sound damping polymeric materials 614, 624, 626, and/or 628 depicted in FIGS. 7A-7C is just one example railing having sound damping polymeric materials affixed thereto. For instance in an aspect not depicted in FIGS. 7A-7C, one or more sound damping polymeric materials can be positioned on the outer surface 621 of the bottom piece 620 and/or on the outer surface 611 of the cap 610. In certain aspects, the cap 610 may include multiple sound damping polymeric materials at positions spaced apart from one another. In various aspects, the bottom piece 620 may include any number of sound damping polymeric materials at any positions along the bottom piece 620.

As discussed above, processes are also disclosed herein for determining a positioning for affixing sound damping polymeric material to a railing to achieve a desired effect, e.g., to lower a tone or resonant frequency of the railing when contacted by a user or object. In such aspects, the processes can include identifying or determining the resonant frequency of the railing, identifying any inconsistencies in the railing, identifying or selecting for use one or more sound damping polymeric materials based on the resonant frequency of the railing, identifying positions on the railing for affixing one or more sound damping polymeric materials, tuning the sound damping polymeric materials, or a combination thereof.

In various aspects, identifying or determining the resonant frequency of the railing can include exposing a railing or portion thereof to various tones from a microphone or other object and detecting, e.g., via an oscilloscope, an increase in amplitude of the wave above the surrounding frequencies (e.g., that were formed at least by the microphone or other object). In such aspects, the increase in amplitude of the wave can be the resonant frequency of the railing, where the railing is absorbing the energy of a specific tone or tones from the microphone and re-emitting it more efficiently compared to other tones, thus increasing the amplitude of the wave. In the same or alternative aspects, a dimensional model of the railing can be utilized to identify a resonant frequency based on a database of known resonant frequencies for various railing shapes.

In certain aspects, as discussed above, one or more parameters of a sound damping polymeric material can be tuned, adjusted, and/or selected for use with a particular railing to achieve a desired resonant frequency, e.g., lowered resonant frequency, and/or to alter the efficiency of energy storage or energy dissipation (e.g., as heat) of the sound damping polymeric material and in turn alter the propagation, rate, and magnitude of vibrational energy of the railing. In certain aspects, the sound damping polymeric materials disclosed herein can be tuned or adjusted for use with a particular railing by adjusting its compositional and/or polymeric properties. In such aspects, adjusting the compositional and/or polymeric properties of the sound damping polymeric material can include adjusting the compositional components of the material to affect one or more of the shear storage modulus, shear loss modulus, stiffness, mass and mode shape, or any combination thereof. In the same or alternative aspects, the sound damping polymeric material can be tuned and/or adjusted by including a backing or modification of a backing material, as discussed above. In these aspects, such backing adjustments may adjust the properties of the sound damping polymeric material, e.g., by altering the shear storage modulus, shear loss modulus, stiffness, mass and mode shape, or any combination thereof, of the sound damping polymeric material. In various aspects, as discussed above, tuning of the sound damping polymeric material may be facilitated by adjusting the dimensional properties of the material, e.g., adjusting a thickness or a shape of the sound damping polymeric material. In aspects, the sound damping polymeric material can be positioned and/or affixed to the railing in a certain arrangement or configuration based on the resonant frequency, the properties of the sound damping polymeric material, or a combination thereof, in order to alter the efficiency of energy storage or energy dissipation (e.g., as heat) of the sound damping polymeric material and in turn alter the propagation, rate, and magnitude of vibrational energy of the railing, to result in lowered, more desirable resonant frequency.

In various aspects, inconsistencies in the railing or material forming the railing, may alter the performance of the material, including altering of the resonant frequency of the railing. In aspects, such inconsistencies may be utilized, alone, or in combination with other adjustments or tuning mentioned above, to determine the positioning and/or selection of the sound damping polymeric material to achieve the desired resonant frequency, e.g., a lower resonant frequency. In certain aspects, the inconsistencies can include potential weakened positions along the railing, e.g., due to a weld, coupling of a fastener, coupling of a baluster, a bend or angle in the railing, the end point of the railing, or a combination thereof. In such aspects, sound damping polymeric material can be positioned proximate to one or more inconsistencies in the railing or railing material. In aspects, sound damping polymeric material can be proximate to one or more inconsistencies in the railing or railing material when such sound damping polymeric material is positioned within 12 inches (304.8 mm), or within 6 inches (152.4 mm) of such an inconsistency, e.g., a weld, fastener, baluster, a bend, an angle, an endpoint, or a combination thereof. In the same or alternative aspects, to achieve a desired resonant frequency, sound damping polymeric material can be positioned outside of such an inconsistency, e.g., 12 inches (304.8 mm) or more, or 6 inches (152.4 mm) or more away from such an inconsistency.

Methods of installation are also contemplated. For example, it is contemplated that a sound damping polymeric material is tuned for a railing on to which the sound damping polymeric material will be installed. Tuning, as provided above, may include adjusting one or more composition, dimensions, locations, and/or orientations of the sound damping polymeric material to effectively dampen vibrations of a metallic railing. The method may also include affixing the sound damping polymeric material to a selected location of the metallic railing. Affixing may be accomplished with an adhesive either as part of the sound damping polymeric material structure or as a separate and discrete adhesive. Additional affixing techniques contemplated include mechanical fasteners (e.g., rivets, screws) and compression fittings. Additional means of affixing a first material to a second material in a railing assembly as are known in the art are contemplated. The affixing of the sound damping polymeric material to a railing or railing assembly may occur at the manufacturer, prior to assembly, and/or after assembly. For example it is contemplated that a selection of sound damping polymeric materials may be provided such that an installer of the railing may affix initially or as a supplemental during/or after assembly of the railing assembly.

As used herein and in connection with the claims listed hereinafter, the terminology “any of clauses” or similar variations of said terminology is intended to be interpreted such that features of claims/clauses may be combined in any combination. For example, an exemplary clause 4 may indicate the method/apparatus of any of clauses 1 through 3, which is intended to be interpreted such that features of clause 1 and clause 4 may be combined, elements of clause 2 and clause 4 may be combined, elements of clause 3 and 4 may be combined, elements of clauses 1, 2, and 4 may be combined, elements of clauses 2, 3, and 4 may be combined, elements of clauses 1, 2, 3, and 4 may be combined, and/or other variations. Further, the terminology “any of clauses” or similar variations of said terminology is intended to include “any one of clauses” or other variations of such terminology, as indicated by some of the examples provided above.

Clause 1. A metallic railing comprising: a first surface; a second surface, wherein the first surface is opposite the second surface; and a sound damping polymeric material affixed to a first portion of the second surface.

Clause 2. The metallic railing of clause 1, wherein the metallic railing comprises aluminum, iron, or alloys thereof.

Clause 3. The metallic railing of clause 1 or 2, wherein the metallic railing comprises a top rail of a railing assembly.

Clause 4. The metallic railing of any of clauses 1 through 3, wherein the first surface is an exterior-facing surface.

Clause 5. The metallic railing of any of clauses 1 through 4, wherein the second surface is an interior-facing surface.

Clause 6. The metallic railing of any of clauses 1 through 5, wherein the second surface is an interior upper surface, an interior side surface, or an interior lower surface.

Clause 7. The metallic railing of any of clauses 1 through 3, wherein the second surface forms an underside of the metallic railing.

Clause 8. The metallic railing of any of clauses 1 through 7, wherein the sound damping polymeric material includes an acrylic material or butyl material.

Clause 9. The metallic railing of any of clauses 1 through 8, wherein the sound damping polymeric material has a thickness in a range of about 9.8 thousandths of an inch (about 0.25 mm) and about 2.8 thousandths of an inch (about 0.07 mm).

Clause 10. The metallic railing of any of clauses 1 through 8, wherein the sound damping polymeric material has a thickness greater than 9.8 thousandths of an inch (about 0.25 mm).

Clause 11. The metallic railing of any of clauses 1 through 10, wherein a length of sound damping polymeric material is less than or equal to a length of the second surface transverse to a longitudinal length of the second surface of the second surface.

Clause 12. The metallic railing of any of clauses 1 through 11, wherein the sound damping polymeric material comprises an adhesive first layer proximate the second surface and a metallic second layer.

Clause 13. The metallic railing of clause 12, wherein the adhesive first layer includes a polymer-based adhesive.

Clause 14. The metallic railing of any of clauses 12 through 13, wherein the metallic second layer and the metallic railing are comprised of the same metal.

Clause 15. The metallic railing of any of clauses 12 through 14, wherein the sound damping polymeric material further comprises a polymer positioned between the adhesive first layer and the metallic second layer.

Clause 16. The metallic railing of any of clauses 1 through 15, further comprising a second sound damping polymeric material affixed to the second surface at a second portion.

Clause 17. The metallic railing of clause 16, wherein the second sound damping polymeric material is discontinuous with the sound damping polymeric material.

Clause 18. The metallic railing of clause 16 or 17, wherein the second sound damping polymeric material has a second length in a longitudinal direction of the metallic railing and the sound damping polymeric material has a first length in a longitudinal direction of the metallic railing, wherein the first length is 99% to 101% the second length.

Clause 19. The metallic railing of clause 16 or 17, wherein the second sound damping polymeric material has a second length in a longitudinal direction of the metallic railing and the sound damping polymeric material has a first length in a longitudinal direction of the metallic railing, wherein the first length is 90% to 110% the second length.

Clause 20. The metallic railing of clause 16 or 17, wherein the second sound damping polymeric material has a second length in a longitudinal direction of the metallic railing and the sound damping polymeric material has a first length in a longitudinal direction of the metallic railing, wherein the first length is greater than 110% the second length.

The use of relative positional terminology, such as top or under, is in reference to a traditional as-installed configuration and orientation.

From the foregoing, it will be seen that aspects herein are well adapted to attain all the ends and objects hereinabove set forth together with other advantages which are obvious and which are inherent to the structure. It will be understood that certain features and sub-combinations are of utility and may be employed without reference to other features and sub-combinations. This is contemplated by and is within the scope of the claims. Since many possible aspects may be made without departing from the scope thereof, it is to be understood that all matter herein set forth or shown in the accompanying drawings is to be interpreted as illustrative and not in a limiting sense.

We claim:

1. A metallic railing comprising:
a first surface;
a second surface, wherein the first surface is opposite the second surface; and
a sound damping polymeric material affixed to a first portion of the second surface.

2. The metallic railing of claim 1, wherein the metallic railing comprises aluminum, iron, or alloys thereof.

3. The metallic railing of claim 1, wherein the metallic railing comprises a top rail of a railing assembly.

4. The metallic railing of claim 1, wherein the first surface is an exterior-facing surface.

5. The metallic railing of claim 1, wherein the second surface is an interior-facing surface.

6. The metallic railing of claim 1, wherein the second surface is an interior upper surface, an interior side surface, or an interior lower surface.

7. The metallic railing of claim 1, wherein the second surface forms an underside of the metallic railing.

8. The metallic railing of claim 1, wherein the sound damping polymeric material includes an acrylic material or butyl material.

9. The metallic railing of claim 1, wherein the sound damping polymeric material has a thickness in a range between about 9.8 thousandths of an inch (about 0.25 mm) and about 2.8 thousandths of an inch (about 0.07 mm).

10. The metallic railing of claim 1, wherein the sound damping polymeric material has a thickness greater than 9.8 thousandths of an inch (about 0.25 mm).

11. The metallic railing of claim 1, wherein a length of sound damping polymeric material is less than or equal to a length of the second surface transverse to a longitudinal length of the second surface of the second surface.

12. The metallic railing of claim 1, wherein the sound damping polymeric material comprises an adhesive first layer and a metallic second layer, the adhesive first layer is more proximate the second surface.

13. The metallic railing of claim 12, wherein the adhesive first layer includes a polymer-based adhesive.

14. The metallic railing of claim 12, wherein the metallic second layer and the metallic railing are comprised of the same metal.

15. The metallic railing of claim 12, wherein the sound damping polymeric material further comprises a polymer positioned between the adhesive first layer and the metallic second layer.

16. The metallic railing of claim 1, further comprising a second sound damping polymeric material affixed to the second surface at a second portion.

17. The metallic railing of claim 16, wherein the second sound damping polymeric material is discontinuous with the sound damping polymeric material.

18. The metallic railing of claim 16, wherein the second sound damping polymeric material has a second length in a longitudinal direction of the metallic railing and the sound damping polymeric material has a first length in the longitudinal direction of the metallic railing, wherein the first length is 99% to 101% the second length.

19. The metallic railing of claim 16, wherein the second sound damping polymeric material has a second length in a longitudinal direction of the metallic railing and the sound damping polymeric material has a first length in the longitudinal direction of the metallic railing, wherein the first length is 90% to 110% the second length.

20. The metallic railing of claim 16, wherein the second sound damping polymeric material has a second length in a longitudinal direction of the metallic railing and the sound damping polymeric material has a first length in the longitudinal direction of the metallic railing, wherein the first length is greater than 110% the second length.
